(19) United States
(12) Patent Application Publication
(10) Pub. No.: US 2016/0147470 A1
(43) Pub. Date: May 26, 2016

(54) METHODS OF RESTORING DATA, METHOD OF STORING DATA AND TAPE STORAGE SYSTEM

(71) Applicant: Fujitsu Technology Solutions Intellectual Property GmbH, Munchen (DE)

(72) Inventor: Dominik Stefanowicz, Lodz (PL)

(21) Appl. No.: 14/930,703

(22) Filed: Nov. 3, 2015

(30) Foreign Application Priority Data
Nov. 25, 2014 (EP) 14194728.3

(51) Int. Cl. G06F 3/06

(52) U.S. Cl. CPC G06F 3/0619; G06F 3/064; G06F 3/0686

(57) ABSTRACT

A method of restoring data from at least two tapes of a tape storage system, a first tape including two sets of data blocks in a first order and a second tape including the two sets of data blocks in a second order, the method including restoring the first set of data blocks from the first tape, and restoring the second set of data blocks simultaneously from the second tape.

### TECHNICAL FIELD

This disclosure relates to methods of restoring data from at least two tapes of a tape storage system, a method of storing data on at least two tapes of a tape storage system for redundant data storage and a tape storage system comprising a data processor and at least two tape storage drives.

### BACKGROUND

Tape storage systems can be used for a backup of data of a computer system. The backup data can be stored on two or more tapes to increase safeguard against failure by redundancy. In conventional tape storage systems, either a complete restoration of all backup data or a partial restoration may be requested by a user. The tape is positioned at the beginning of the relevant data and the data is restored. Both the positioning of the tape to an access position as well as restoring large volumes of data is time consuming. With increasing amounts of backup data, it is desirable to improve the restoration time.

It could therefore be helpful to provide methods of restoring data from at least two tapes, a method of storing data on at least two tapes and a tape storage system which increase the speed of restoration operations.

### SUMMARY

I provide a method of restoring data from at least two tapes of a tape storage system, a first tape including two sets of data blocks in a first order and a second tape including the two sets of data blocks in a second order, the method including restoring the first set of data blocks from the first tape, and restoring the second set of data blocks simultaneously from the second tape.

I also provide a method of restoring at least one data block from a tape storage system using at least two tapes, a first tape including two sets of data block in a first order and a second tape including the two sets of data blocks in a second order, the method including determining a position of the at least one data block to be restored for the two tapes, and restoring the data from the tape requiring a minimal time to access the determined position.

I further provide a method of storing data on at least two tapes of a tape storage system for redundant data storage, the data being split into data blocks, the method including writing a first set of the data blocks and a second set of the data blocks on a first tape, based on a first order, and writing the first set of the data blocks and the second set of the data blocks on a second tape, based on a second order, the second order being different from the first order.

### BRIEF DESCRIPTION OF THE DRAWINGS

FIG. 1 schematically shows a tape storage system.

FIG. 2 shows a flow diagram of a method of storing data on at least two tapes of a tape storage system.

FIG. 3 shows a flow diagram of a method of restoring data from at least two tapes of a tape storage system.

FIG. 4 schematically shows another example of a tape storage system.

### LIST OF REFERENCE SYMBOLS

10 tape storage system
11 first tape
12 second tape
B1, B2, Bn/2, Bn/2+1, Bn−1, Bn data block
S1 first set
S2 second set
S1′, S2′ inverse subset
20 to 23, 30 to 35 method steps

### DETAILED DESCRIPTION

I provide a method of restoring data from at least two tapes of a tape storage system. A first tape comprises two sets of data blocks in a first order and a second tape comprises the two sets of data blocks in a second order. The method comprises the step of:
restoring the first set of data blocks from a first tape, and restoring the second set of data blocks simultaneously from the second tape.

Tape storage systems with more than one tape may be used for redundant data storage systems. In such systems, data is stored on at least two tapes so that the data is still available if one tape is destroyed or contains incorrect data. The data on each tape can be split into data blocks such as logical volumes or sectors. Data blocks on a first tape are stored in a first order. This first order can be pre-calculated. The data can be read from the tapes only in one direction. To simultaneously read different parts of the tapes without repositioning the tapes, the data blocks are stored on the second tape in a different order. If data blocks are stored on another tape in a second order different from the first order, the physical distances for positioning the tapes in a way that a reading head can read one specific data block will be different. Therefore, positioning times will be different, too. By restoring a first part of data blocks from the first tape and restoring second part of data blocks simultaneously from the second tape an improvement in reading time can be obtained.

I provide a method of restoring at least one data block from a tape storage system. The tape storage system uses at least two tapes, a first tape comprising two sets of data blocks in a first order and a second tape comprising the two sets of data blocks in a second order. The method comprises the steps of:
determining a position of the at least one data block to be restored for the two tapes; and
restoring the data from the tape requiring a minimal time to access the determined position.

If a user does not want to perform a complete restoration of data, but a restoration of specific data blocks, restoration time can be decreased using this method. By determining a tape with the lowest positioning time to access the position of the stored data block, the restoration time can be controlled. A time benefit is gained by choosing the tape with the lowest positioning time.

I also provide a method of storing data on at least two tapes of a tape storage system for redundant data storage. The data is split up into data blocks. The method comprises the steps of:
writing a first set of the data blocks and a second set of the data blocks on a first tape, based on a first order; and
writing the first set of the data blocks and the second set of the data blocks on a second tape, based on a second order, the second order being different from the first order.

By writing the data blocks on the tapes in a different order, the data blocks are stored such that two identical copies of a specific data block are stored at different positions of the tapes. That means that a distance from a beginning of a tape to the place on which a specific data block is stored, is different for each tape. If reading the tapes starts at a similar position on both tapes, for example, a very beginning of both tapes, the time to reach the position of the specific data block will be different. This difference can be used in a restoration operation to decrease the restoration time. In particular, by storing the data blocks on the tapes in different orders, the methods may be performed.

To write data on a tape of a tape drive, data is split into data blocks such as logical volumes or sectors. To write the data blocks on the tape, the data blocks can be indexed or enumerated. For example, the first data block written on a first tape has the index number 1. The second data block written on the first tape has the index number 2. The last data block written on the first tape has the index number n. In this way every data block is written to the first tape. To write the data on a second tape of the tape drive, the split data blocks are written on the second tape in a second order.

A set of data blocks can be understood as a group of two data blocks or more. For example, a first set of data blocks may comprise one half of all data blocks written on a tape and a second set of data blocks may comprise the other half of all data blocks written on a tape. In another example, the first set of data blocks may comprise only a small number of data blocks and the second set of data blocks comprises other data blocks, but also a small number of data blocks. There may be data blocks written on the tapes and that are not part of the sets of data blocks.

The index numbers are a simple example to improve an understanding of the methods. Other addressing systems and/or indexing methods may be used by tape storage systems. They can comprise position codes not written on the tapes, but stored in a table to associate data with data block positions on tapes.

Advantageously, the second order is based on the first order in reverse.

For example, the first order used to write the data blocks on the first tape may be increasing, starting with index number 1 to index number n. Therefore, the second order based on the first order in reverse, starts with the last data block corresponding to the index number n. From thereon, each data block with decreasing index numbers is written on the tape. A second data block on the second tape would therefore be the data block with the index number n−1. The last data block written on the second tape in this case, would then be the data block with the index number 1.

A benefit of the method is that positioning the tape to access every logical volume is reduced significantly by choosing the tape with the lower positioning time. Moreover, a restoration time for a complete restoration takes only (about) half of the time of performing a restoration of only one tape because two different halves of the data blocks may be simultaneously restored from both tapes.

Advantageously, the first set and the second set each comprise more than one data block and an order of the data blocks of the second part is reversed with respect to the order of the data blocks of the first part.

By reversing the order of the sets of the data blocks, it is possible to arrange some data blocks at specific tape positions, still using the benefit of a fast restoration. For example, a data block known to be used very frequently is stored at a very beginning of one tape and at a rear end of the other tape.

I further provide a tape storage system. The storage system comprises a data processor and at least two tape storage drives that store data in data blocks using a method of storing data on tapes and/or using a method to restore data.

My methods and systems will be explained in greater detail below with reference to several drawings. The same reference signs will be used for like components of different examples.

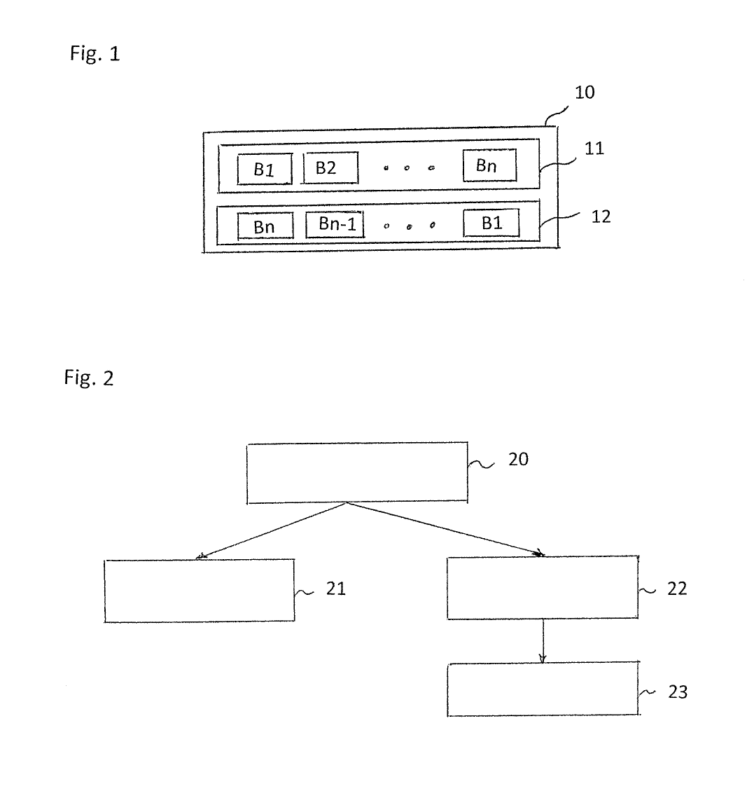

FIG. 1 shows a tape storage system 10. The tape storage system 10 is adapted/configured for redundant data storage. The tape storage system 10 comprises two tape drives. Each tape drive accommodates one tape. By storing data redundant on more than one tape, the data is still available, if one tape is destroyed or contains incorrect data. The tape storage system 10 in this example comprises two tape drives. A first tape 11 is arranged in a first tape drive and a second tape 12 in a second tape drive. The number of tape drives and tapes can vary in other examples so that the tape storage system 10 comprises, for example, three or more tape drives.

To store the data on the first tape 11 and the second tape 12, the data is split up into data blocks B1, . . . , Bn. These data blocks B1, . . . , Bn are written on the first tape 11 and the second tape 12 as logical volumes.

The data blocks B1, . . . , Bn are written on the tapes to specific positions. On the first tape 11, the data blocks B1, . . . , Bn are written in a first order with increasing index numbers. This results in an increasing order of data blocks B1, . . . , Bn on the first tape 11. The data block B1 with the lowest index number is written at a first position. At a second position, the data block B2 with the next index number is written. On the second tape 12, the data blocks B1, . . . , Bn are written in a reversed order. At a first position on the second tape 12, data block Bn is written. On a second position, the data block Bn−1 is written. While the last data block of the first tape 11 is the data block Bn, on the second tape 12, the last data block is the data block B1.

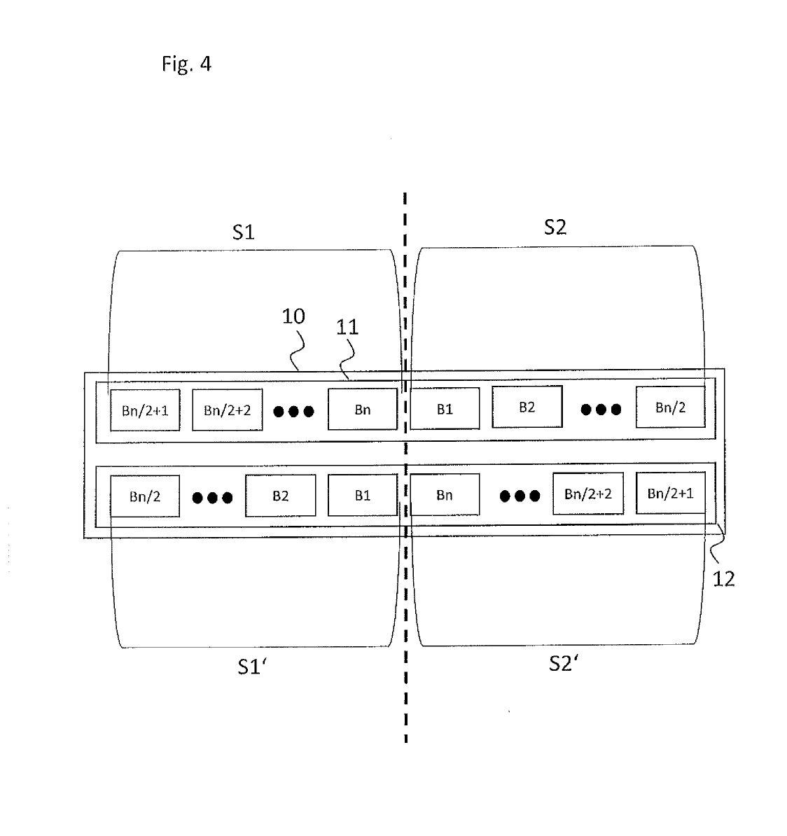

FIG. 4 shows another example of a tape storage system 10. A set of data blocks B1, . . . , Bn is split up into a first set S1 of data blocks B1, B2, . . . , Bn/2 comprising the data blocks B1, B2, . . . , Bn/2 with index numbers 1 to n/2 and a second set S2 of data blocks Bn/2+1, . . . , Bn with the index numbers n/2+1 to n. These sets can be seen as subsets of the set of data blocks B1, . . . , Bn. The first set S1 of data blocks B1, B2, . . . , Bn/2 and the second set S2 of data blocks Bn/2+1, Bn/2+2, . . . , Bn are written on the first tape 11 in a reversed order. That is, the second set S2 of data blocks Bn/2+1, . . . , Bn is written on the first tape 11 before the first set S1 of data blocks B1, B2, . . . , Bn/2 is written on the first tape 11. On the second tape 12, both, the order of the data blocks B1, . . . , Bn of each set of data blocks B1, . . . , Bn and the order of the sets of data blocks B1, . . . , Bn are reversed. In this way, inversed subsets S1′ and S2′, comprising data blocks Bn/2, . . . , B2, B1 and Bn, . . . , Bn/2+2, Bn/2+1 are created and written to the second tape 12.

In another example not shown, four tapes are used to store the data blocks B1, . . . , Bn. The first two tapes comprise the data blocks B1, . . . , Bn in orders as described with respect to the example of FIG. 1. The third and fourth tape comprise the data blocks B1, . . . , Bn in orders as described with respect to the example of FIG. 4. Therefore the data blocks B1, . . . , Bn are stored on four different tapes in four different orders. In this example, access time to stored data blocks B1, . . . , Bn is further decreased. In general, the number of subsets and tapes is not limited.

In yet another example not shown, only a few data blocks B1, . . . , Bm are combined to form a first set of data blocks B1, . . . , Bm and a few other data blocks Bo, . . . , Bp, which are not included in the first set of data blocks B1, . . . , Bm, are combined to form a second set of data blocks Bo, . . . , Bp. During writing the first set of data blocks B1, . . . , Bm and the second set of data blocks Bo, . . . , Bp on the first tape, a first order is used. During writing the first set of data blocks B1, . . . , Bm and the second set of data blocks Bo, . . . , Bp on the second tape, a second order is used. Other data blocks Bq, . . . , Bn may be written in any order on both tapes.

If the data blocks B1, . . . , Bn are written on the first tape 11 and the second tape 12 in a way as described above, a fast restore of the data can be performed using one of the methods described below.

To perform a complete restoration of the stored data, for example, as a disaster recovery, the first tape 11 and the second tape 12 are simultaneously used for the restoration operation, both starting at a first position. With this technique, the restore can be performed twice as fast as a restore from only one tape. While the data block B1 is restored from the first tape 11, the data block Bn is restored from the second tape 12. While the data block B2 is restored from the first tape 11, the data block Bn−1 is restored from the second tape 12. So, when half of the data blocks B1, . . . , Bn are restored from the first tape 11, the other half of the data blocks B1, . . . , Bn has already been restored from the second tape 12.

In another example, if only one data block B1, . . . , Bn or a part of the data blocks B1, . . . , Bn has to be restored, the tape with the lower access time is used. To determine which tape has the lower access time, access times for both tapes, the first tape 11 and the second tape 12 are determined. For example, if the data block B2 is to be restored, the time to position the first tape 11 to the position of data block B2 is determined and the time to position the second tape 12 to the position of data block B2 is determined. A first reading head of the first tape drive is configured to read the data of the first tape 11. A second reading head of the second tape drive is configured to read the data of the second tape 12. Assuming that the first reading head and the second reading head are positioned at the very beginning of each tape, the position of the data block B2 on the first tape 11 is closer to the first reading head than the position of the data block B2 on the second tape 12 to the second reading head. Therefore, the first tape 11 is chosen for the restoration operation.

FIG. 2 shows a flow diagram for storing data on a tape storage system 10. In step 20, the tape storage system 10 receives data split up into different data blocks B1, . . . , Bn. For this method, it is not essential where the splitting up of the data is performed. It can be performed in the tape storage system 10. It can also be performed in an external computer system or another device, for example.

In step 21, the received data blocks B1, . . . , Bn are written to the first tape 11 in the order in which the tape storage system 10 received the data. In parallel to step 21, in step 22, an alternative order to write the data blocks B1, . . . , Bn on the second tape 12 is determined. In step 23, the data blocks B1, . . . , Bn are written to the second tape 12 in the calculated order, determined in step 22.

Alternatively, step 21 includes generating an order to write the data blocks B1, . . . , Bn on the first tape 11.

In another alternative, a pre-given order to write data blocks B1, . . . , Bn on the first tape 11 and the second tape 12 is provided in step 20. In this example, step 22 is not necessary and step 21 and step 23 are performed in parallel after step 20.

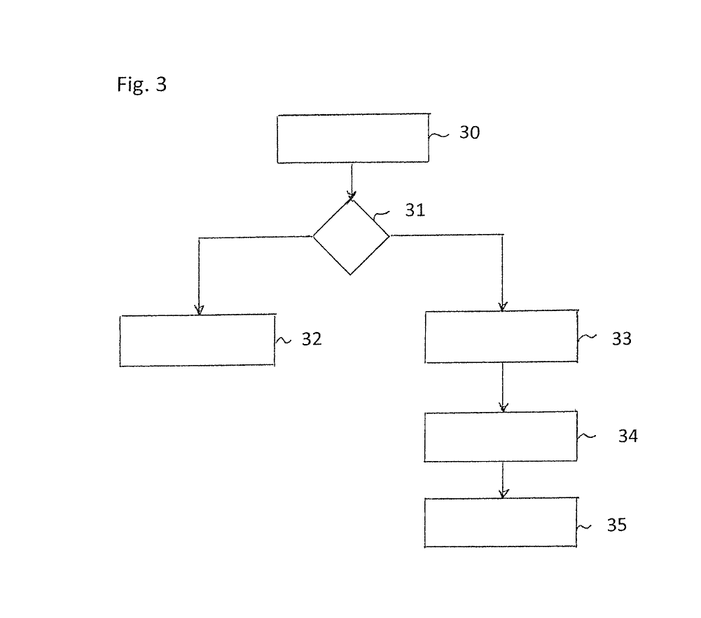

FIG. 3 shows a flow diagram for restoring data from at least two tapes of a tape storage system 10. In step 30, a restore command is received.

In step 31 the nature of the restore command is determined. Two different restore commands are considered. In a first case, a complete restore is requested. In a second case, only a partial restore is requested. If the restore command requires a complete restore, the restoration is initialized in step 32.

Step 32 includes starting and performing the restore from the first tape 11 and from the second tape 12. The restoration from the first tape 11 and from the second tape 12 is performed simultaneously.

If only a part of the data has to be restored, the method proceeds to step 33 instead. The data blocks B1, . . . , Bn relevant for this partial restoration may be stored at different positions on both tapes 11, 12. Therefore, the reading heads of both tape drives need different times to be positioned at the data blocks B1, . . . , Bn. These positioning times for the first tape 11 and the second tape 12 are determined in step 33. The positioning data needed to determine the positioning times may be part of the restoration command. In another example, the positioning data is stored in a lookup table or a register file of the tapes or the tape drive system.

In step 34 the determined positioning times are evaluated. The tape with the lower positioning time is chosen for the restore operation.

In step 35 the restore operation is performed from the tape with the lowest positioning time.

Although the methods and systems have been described in connection with specific forms thereof, it will be appreciated that a wide variety of equivalents may be substituted for the specified elements described herein without departing from the spirit and scope of this disclosure as described in the appended claims.

1. A method of restoring data from at least two tapes of a tape storage system, a first tape comprising two sets of data blocks in a first order and a second tape comprising the two sets of data blocks in a second order, the method comprising:
restoring the first set of data blocks from the first tape; and
restoring the second set of data blocks simultaneously from the second tape.

2. A method of restoring at least one data block from a tape storage system using at least two tapes, a first tape comprising two sets of data blocks in a first order and a second tape comprising the two sets of data blocks in a second order, the method comprising:
determining a position of the at least one data block to be restored for the two tapes; and
restoring the data from the tape requiring a minimal time to access the determined position.

3. A method of storing data on at least two tapes of a tape storage system for redundant data storage, the data being split into data blocks, the method comprising:
writing a first set of the data blocks and a second set of the data blocks on a first tape, based on a first order; and
writing the first set of the data blocks and the second set of the data blocks on a second tape, based on a second order, the second order being different from the first order.

4. The method of claim 1, wherein the second order is based on the first order in reverse.

5. The method of claim 2, wherein the second order is based on the first order in reverse.

6. The method of claim 3, wherein the second order is based on the first order in reverse.

7. The method of claim 1, wherein the first set of the data blocks and the second set of the data blocks each comprise more than one data block and an order of the data blocks of the second set of the data blocks is reversed with respect to the order of the data blocks in the first set of the data blocks.

8. The method of claim 2, wherein the first set of the data blocks and the second set of the data blocks each comprise more than one data block and an order of the data blocks of the second set of the data blocks is reversed with respect to the order of the data blocks in the first set of the data blocks.

9. The method of claim 3, wherein the first set of the data blocks and the second set of the data blocks each comprise more than one data block and an order of the data blocks of the second set of the data blocks is reversed with respect to the order of the data blocks in the first set of the data blocks.

10. A tape storage system comprising a data processor and at least two tape storage drives that store data in data blocks according to the method of claim 3 to store data on tapes.

11. A tape storage system comprising a data processor and at least two tape storage drives that store data in data blocks according to the method of claim 1 to restore data.

12. A tape storage system comprising a data processor and at least two tape storage drives that store data in data blocks according to the method of claim 2 to restore data.
